(19) United States
(12) Patent Application Publication
(10) Pub. No.: US 2017/0088308 A1
(43) Pub. Date: Mar. 30, 2017

(54) JOINT ASSEMBLY FOR A CONTAINER

(71) Applicant: GM GLOBAL TECHNOLOGY OPERATIONS LLC, Detroit, MI (US)

(72) Inventors: Leonard Barry Griffiths, Fenton, MI (US); Michael A. Karram, Flint, MI (US)

(73) Assignee: GM GLOBAL TECHNOLOGY OPERATIONS LLC, Detroit, MI (US)

(21) Appl. No.: 14/864,972

(22) Filed: Sep. 25, 2015

(51) Int. Cl. B65D 6/34; F02F 7/00; F01M 11/00

(52) U.S. Cl. CPC B65D 7/44; B65D 11/22; F01M 11/0004; F02F 7/0021; F01M 2011/0091; F01M 2011/0054

(57) ABSTRACT

A joint assembly includes a first container portion, a second container portion, a band strip, and a fastener. The first container portion has a first flange including a first sealing surface and a first outer surface. The second container portion has a second flange including a second sealing surface and a second outer surface. The second sealing surface is configured to cooperate with the first sealing surface to form together a sealed connection. The fastener is configured to attach the band strip to one of the first and second container portions. An inner surface of the band strip is configured to engage at least one of the first and second outer surfaces such that the sealing surfaces of the first and second flanges are fixed with respect to one another when the band strip is attached to at least one of the first and second container portions.

### TECHNICAL FIELD

This disclosure relates to a joint assembly for a container.

### BACKGROUND

A vehicle may include a container for retaining a fluid. The container may include a plurality of flanged portions that are joined together and sealed at a sealed connection. For example, the container may be an engine oil container formed by joining an oil pan portion to an engine block portion or the container may be a transmission fluid container formed by joining a transmission fluid pan portion to a transmission housing portion.

### SUMMARY

A joint assembly, a powertrain, and a vehicle are provided herein. The joint assembly is configured to secure together flanged portions of a container. The joint assembly includes a first container portion, a second container portion, a band strip, and a fastener. The first container portion has a first flange including a first sealing surface and a first outer surface. The second container portion has a second flange including a second sealing surface and a second outer surface. The second sealing surface is configured to cooperate with the first sealing surface to form together a sealed connection configured to retain a fluid in the container. The band strip has an inner surface. The fastener is configured to attach the band strip to one of the first and second container portions. The inner surface of the band strip is configured to engage at least one of the first and second outer surfaces such that the sealing surfaces of the first and second flanges are fixed with respect to one another when the band strip is attached to at least one of the first and second container portions.

The powertrain includes a container having flanged portions and a joint assembly configured to secure together the flanged portions of the container. The joint assembly includes a first container portion, a second container portion, a band strip, and a fastener. The first container portion has a first flange including a first sealing surface and a first outer surface having a first outer profile. The second container portion has a second flange including a second sealing surface and a second outer surface having a second outer profile. The second sealing surface is configured to cooperate with the first sealing surface to form together a sealed connection configured to retain a fluid in the container. The band strip has an inner surface including an inner profile. The fastener is configured to attach the band strip to one of the first and second container portions. The inner surface of the band strip is configured to engage at least one of the first and second outer surfaces such that the sealing surfaces of the first and second flanges are fixed with respect to one another when the band strip is attached to at least one of the first and second container portions. The outer profiles of the first and second flanges form together a V-shaped outer profile, and the inner profile of the band strip is configured to sufficiently conform to the V-shaped outer profile such that a clamping force biases the sealing surfaces of the first and second flanges toward one another.

The vehicle includes a container having flanged portions and a joint assembly configured to secure together the flanged portions of the container. The joint assembly includes a first container portion, a second container portion, a band strip, and a fastener. The first container portion has a first flange including a first sealing surface and a first outer surface. The second container portion has a second flange including a second sealing surface and a second outer surface. The second sealing surface is configured to cooperate with the first sealing surface to form together a sealed connection configured to retain a fluid in the container. The band strip has an inner surface. The fastener is configured to attach the band strip to one of the first and second container portions. The inner surface of the band strip is configured to engage at least one of the first and second outer surfaces such that the sealing surfaces of the first and second flanges are fixed with respect to one another when the band strip is attached to at least one of the first and second container portions.

The joint assembly, the powertrain, and the vehicle disclosed herein restrict the movement of the sealing surfaces of the first and second flanges of the container with respect to one another such that the fluid is retained in the container. This disclosure applies to any container having a plurality of flanged portions, to any powertrain, and to any vehicle, including but not limited to a car, a truck, a bus, a train, an airplane, and a boat.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a fragmentary schematic perspective illustration of a container having flanged portions and a joint assembly configured to secure together the flanged portions of the container, with fasteners exploded or removed for clarity.

FIG. 2 is a schematic cross-sectional illustration, partially exploded and partially in elevation, of the joint assembly of FIG. 1, taken at line 2-2 of FIG. 1, including the fasteners.

FIG. 3 is a schematic cross-sectional illustration, partially in elevation, of an alternative embodiment of the joint assembly of FIG. 1, taken at line 2-2 of FIG. 1, including the fasteners.

FIG. 4 is a schematic, exploded cross-sectional illustration of the joint assembly of FIG. 1, taken at the sealed connection between the flanged portions of the container.

### DETAILED DESCRIPTION

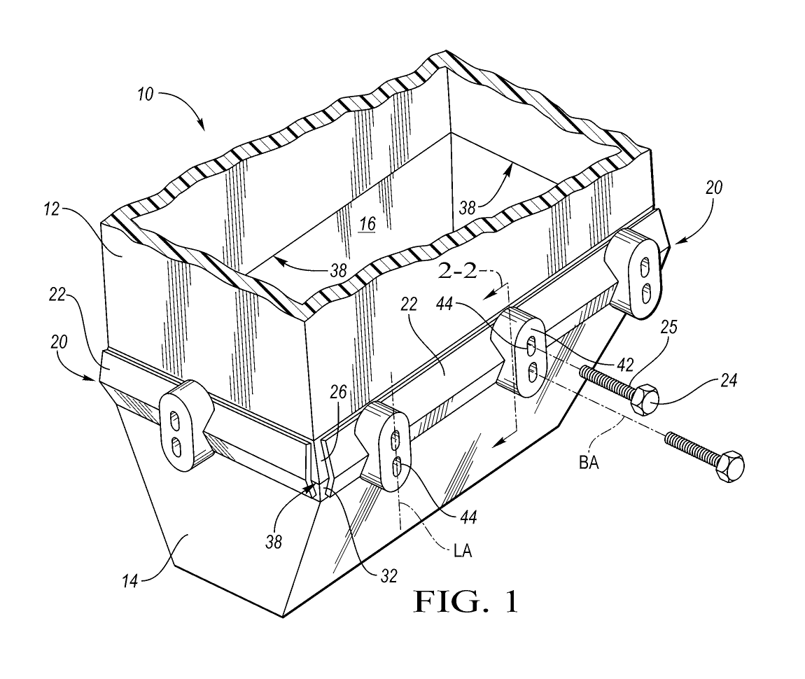

Referring to the drawings, wherein like reference numbers refer to like components throughout the views, FIG. 1 shows a container 10 having a first flanged container portion 12 and a second flanged container portion 14 joined to the first container portion 12 via a joint assembly 20. The container 10 encloses an interior 16 configured to retain a fluid (not shown). Parts and/or mechanisms (not shown) may also be enclosed in the interior 16 of the container 10, as appropriate. The container 10 may include more than two flanged container portions. The container 10 may be included in a powertrain (not shown) of a vehicle (not shown) or in any other part of the vehicle. Non-limiting examples of containers 10 include an engine oil container formed by joining an oil pan portion to an engine block portion, a transmission fluid container formed by joining a transmission fluid pan portion to a transmission housing portion, and a brake fluid reservoir formed by joining an upper portion and a lower portion of the brake fluid reservoir. Alternatively the container 10 may not be included in a powertrain or a vehicle. The container may be independent of any machine or manufacture or may be included in a machine or manufacture.

The first container portion 12 may be made of a metal material, such as a steel, magnesium, or aluminum alloy, or may be made of a non-metal material, such as a plastic, a reinforced plastic, or a composite material. The second container portion 14 may be made of a metal material, such as a steel, magnesium, or aluminum alloy, or may be made of a non-metal material, such as a plastic, a reinforced plastic, or a composite material. The first container portion 12 and the second container portion 14 may be made of different materials having different mater properties. For example, the first container portion 12 may be made of a metal alloy material and the second container portion 14 may be made of a composite material having a thermal expansion coefficient that is different than the metal allow material.

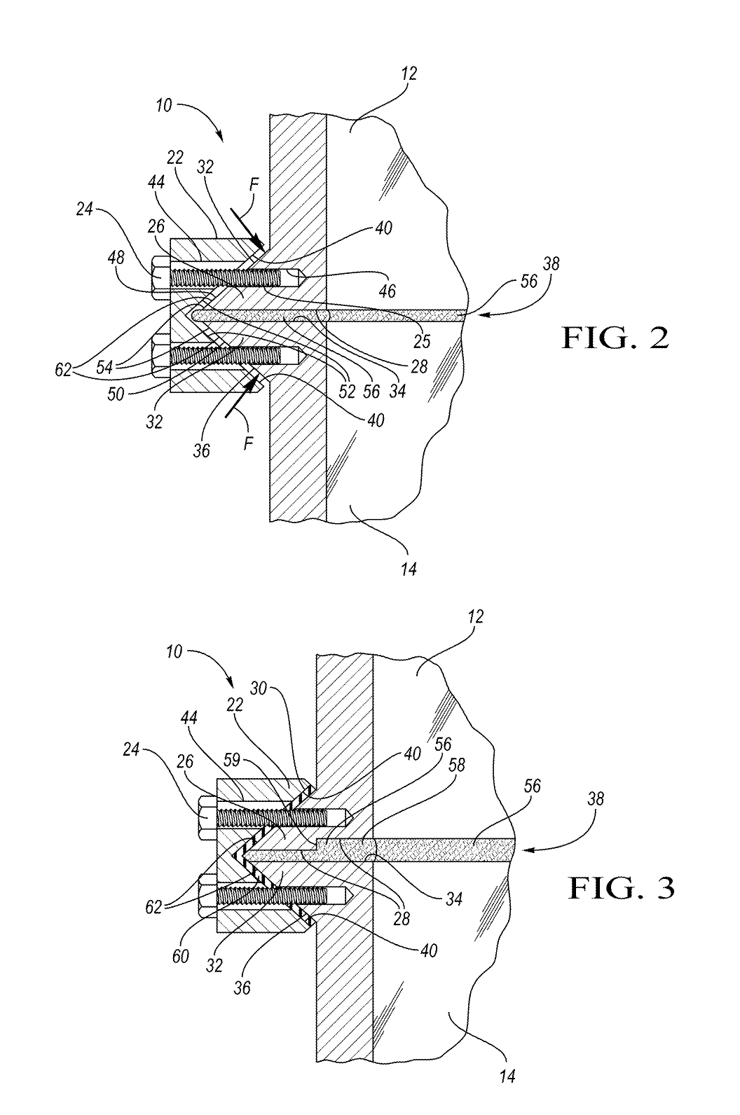

Referring now to FIGS. 1-2, the joint assembly 20 is configured to secure together the first and second flanged container portions 12, 14 of the container 10. The joint assembly 10 includes the first flanged container portion 12, the second flanged container portion 14, a band strip 22, and a fastener 24. The first container portion 12 has a first flange 26 including a first sealing surface 28 and a first outer surface 30. The second container portion 14 has a second flange 32 including a second sealing surface 34 and a second outer surface 36. The second sealing surface 34 is configured to cooperate with the first sealing surface 28 to form together a sealed connection 38 configured to retain the fluid (not shown) in the container 10.

The band strip 22 has an inner surface 40. The band strip 40 may be made of a metal material, such as a steel, magnesium, or aluminum alloy, or may be made of a non-metal material, such as a plastic, a reinforced plastic, or a composite material. The fastener 24 is configured to attach the band strip 22 to one of the first container portion 12 and the second container portion 14. The inner surface 40 of the band strip 22 is configured to engage at least one of the first outer surface 30 and second outer surface 36 such that the first sealing surface 28 of the first flange 26 and the second sealing surface 34 of the second flange 32 are fixed with respect to one another when the band strip 22 is attached to at least one of the first container portion 12 and the second container portion 14.

The fastener 24 may be a bolt, as shown, having threads 25, or may be any other suitable fastener. The threads 25 of the bolt 24 may be configured to engage a threaded hole 46 in one of the first and second container potions 12, 14. The bolt 24 may have a bolt axis (axis BA). The bolt axis (axis BA) may be substantially parallel to the sealing surfaces 28, 34 of the first and second flanges 26, 32 when the band strip 22 is attached to one of the first and second container portions 12, 14 via the fastener 24.

The joint assembly 20 may include a plurality of fasteners 24. The plurality of fasteners 24 may be configured to attach the band strip 22 to one or both of the first container portion 12 and the second container portion 14. The band strip 22 may be configured with one or more attachment features 42. The attachment feature 42 may include one or more slots 44. The one or more slots 44 may each have a long axis (axis LA). The long axis (axis LA) of the slot 44 may be substantially normal to the first and second sealing surfaces 28, 34. The plurality of fasteners 24 may be configured to attach the band strip 22 to one or both of the first container portion 12 and second container portion 14 through the plurality of slots 44.

Referring now to FIG. 2, the first outer surface 30 of the first flange 26 has a first outer profile 48, and the second outer surface 36 of the second flange 32 has a second outer profile 50. The outer profiles 48, 50 of the first and second flanges 26, 32 form together an outer profile 54. The outer profile 54 may be V-shaped, as shown, or may be any other suitable shape. For example, the outer profile 54 of the first and second flanges 26, 32 may be C-shaped, U-shaped, cove-shaped, and/or beveled.

The inner surface 40 of the band strip 22 has an inner profile 52. The inner profile 52 of the band strip 22 is configured to sufficiently conform to the outer profile 54 such that a clamping force (arrow F) biases the sealing surfaces 28, 34 of the first and second flanges 26, 32 toward one another. The inner profile 52 of the band strip 22 may be V-shaped, as shown, or may be any other suitable shape. For example, the inner profile 52 of the band strip 22 may be C-shaped, U-shaped, cove-shaped, and/or beveled.

The inner profile 52 of the band strip 22 may be complimentary with the outer profile 54 of the first and second flanges 26, 32. For example, if the outer profile 54 of the first and second flanges 26, 32 is C-shaped, the inner profile 52 of the band strip 22 may also be C-shaped.

The inner profile 52 of the band strip 22 may be configured to conform to the outer profile 54 of the first and second flanges 26, 32 over the entire inner profile 52, as shown. Alternatively, the inner profile 52 of the band strip 22 may be configured to conform to one or more portions of the outer profile 54 of the first and second flanges 26, 32. The inner surface 40 of the band strip 22 may contact a combined outer surface 62 formed by the outer surfaces 30, 36 of the first and second flanges 26, 30 over the entire inner surface 40 of the band strip 22, as shown. Alternatively, the inner surface 40 of the band strip 22 may contact the combined outer surface 62 of the first and second flanges 26, 30 over one or more portions of the inner surface 40 of the band strip 22.

The joint assembly 20 may include a seal 56 disposed between the sealing surfaces 28, 34 of the first and second flanges 26. 32. The seal 56 may be a curable sealant such as a room temperature vulcanizing rubber. Alternatively, the seal 56 may be a compression gasket, a partially cured pre-formed gasket, or any other suitable seal, as known to those skilled in the art.

Referring now to FIG. 3, one of the first and second sealing surfaces 28, 34 may include a recessed portion 58 configured so that the seal 56 flows or deforms therein. The recessed portion 58 may be formed by a step 59 in one of the first and second sealing surfaces 28, 34. Alternatively, the recessed portion 58 may be a round, oval, square, rectangular, or triangular groove (not shown) or may be any other suitable feature formed in one of the first and second sealing surfaces 28, 34. The seal 56 may be disposed in the recessed portion 58. In another alternative, both of the first and second sealing surfaces 28, 34 may include a recessed portion 58. The first and second sealing surfaces 28, 34 may have other configurations as appropriate.

The joint assembly 20 may include an elastomer layer 60 disposed between the inner surface 40 of the band clamp 22 and the combined outer surface 62 formed by the outer surfaces 30, 36 of the first and second flanges 26, 30. The elastomer layer 60 may be disposed between the entire inner surface 40 of the band clamp 22 and the combined outer surface 62. Alternatively, the elastomer layer 60 may be disposed between one or more portions of the inner surface 40 of the band clamp 22 and the combined outer surface 62.

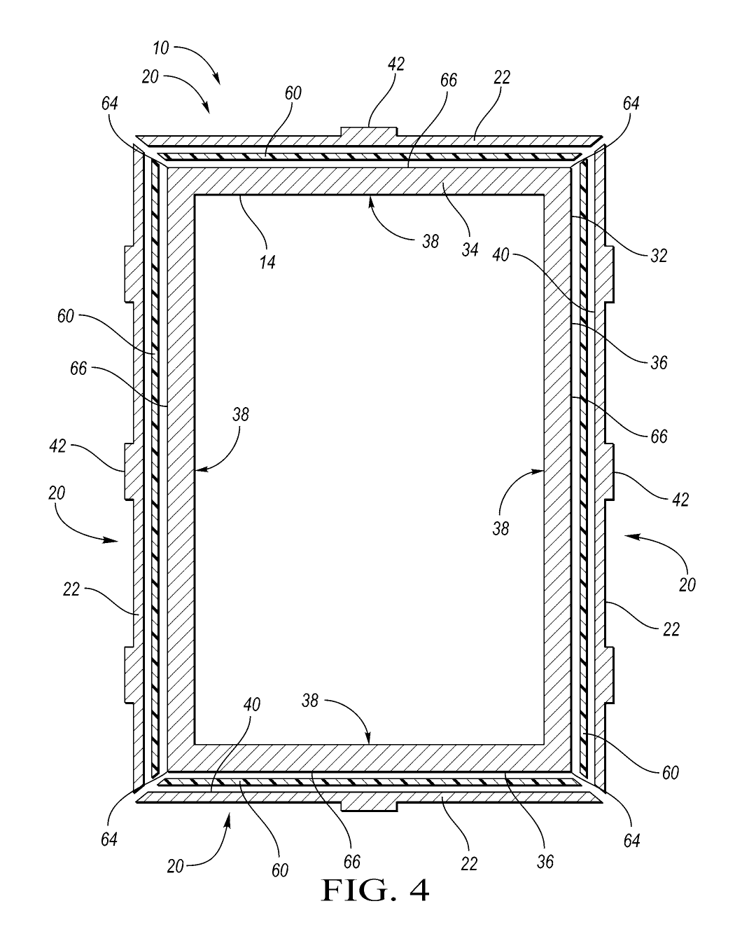

Referring now to FIG. 4, an exploded cross section of the joint assembly 20 at the sealed connection 38 between the first sealing surface 28 and the second dealing surface 34 is shown. In this embodiment, the first and second flanges 26, 32 of the first and second container portions 12, 14 form four corners 64 and four straight portions 66. In other embodiments, the first and second flanges 26, 32 of the first and second container portions 12, 14 may include convex or concave curved portions (not shown), more or less than four corners 64, including no corners 64, and more or less than four straight portions 66, including no straight portions 66. The corners 64 may be right angles, as shown, or may be any other suitable angle. The corners 64 may be radiused or curved.

In the embodiment shown, four band strips 22 and four elastomer layers 60 are included in the joint assembly 20. One band strip 22 is used for each straight portion of the first and second flanges 26, 32 of the first and second container portions 12, 14. In an alternative embodiment, one or more of the band strips 22 may extend around one or more of the corners 64 formed in the first and second flanges 26, 32 of the first and second container portions 12, 14. For example, for the four corner 64 and four straight portion 66 first and second flange 26, 32 configuration shown, two L-shaped band strips 22 may be used.

In another embodiment of the joint assembly 20, one or more band strips 22 may be configured to conform to first and second flanges 26, 32 that include convex or concave curved portions. Other embodiments may include a combination of a joint assembly 20 including a band strip 22 and a conventional or alternative joint assembly (not shown) to connect the first and second flanges 26, 32 of the first and second container portions 12, 14.

While the best modes for carrying out the many aspects of the present teachings have been described in detail, those familiar with the art to which these teachings relate will recognize various alternative aspects for practicing the present teachings that are within the scope of the appended claims.

1. A joint assembly configured to secure together flanged portions of a container, comprising:
a first container portion having a first flange including a first sealing surface and a first outer surface;
a second container portion having a second flange including a second sealing surface and a second outer surface, wherein the second sealing surface is configured to cooperate with the first sealing surface to form together a sealed connection configured to retain a fluid in the container;
a band strip having an inner surface; and
a fastener configured to attach the band strip to one of the first and second container portions;
wherein the inner surface of the band strip is configured to engage at least one of the first and second outer surfaces such that the sealing surfaces of the first and second flanges are fixed with respect to one another when the band strip is attached to at least one of the first and second container portions.

2. The joint assembly of claim 1, wherein the fastener is a bolt having an bolt axis; and
wherein the bolt axis is substantially parallel to the sealing surfaces when the band strip is attached to one of the first and second container portions.

3. The joint assembly of claim 2, comprising a plurality of fasteners,
wherein the plurality of fasteners are configured to attach the band strip to both the first container portion and the second container portion.

4. The joint assembly of claim 3, wherein the band strip is configured with a plurality of slots each having a long axis substantially normal to the first and second sealing surfaces; and
wherein the plurality of fasteners are configured to attach the band strip to the first and second container portions through the plurality of slots.

5. The joint assembly of claim 1, wherein the first outer surface of the first flange has a first outer profile, the second outer surface of the second flange has a second outer profile, and the inner surface of the band strip has an inner profile;
wherein the outer profiles of the first and second flanges form together a V-shaped outer profile; and
wherein the inner profile of the band strip is configured to sufficiently conform to the V-shaped outer profile such that a clamping force biases the sealing surfaces of the first and second flanges toward one another.

6. The joint assembly of claim 1, further comprising a seal disposed between the sealing surfaces of the first and second flanges.

7. The joint assembly of claim 6, wherein the seal is a curable sealant.

8. The joint assembly of claim 7, one of the first and second sealing surfaces includes a recessed portion; and
wherein the curable sealant is disposed in the recessed portion.

9. The joint assembly of claim 1, further comprising an elastomer layer disposed between the inner surface of the band clamp a combined outer surface formed by the outer surfaces of the first and second flanges.

10. The joint assembly of claim 1, wherein one of the first and second container portions is made of a non-metal material.

11. A powertrain including a container having flanged portions, comprising:
a joint assembly configured to secure together the flanged portions of the container, including:
a first container portion having a first flange including a first sealing surface and a first outer surface having a first outer profile;
a second container portion having a second flange including a second sealing surface and a second outer surface having a second outer profile, wherein the second sealing surface is configured to cooperate with the first sealing surface to form together a sealed connection configured to retain a fluid in the container;
a band strip having an inner surface including an inner profile; and
a fastener configured to attach the band strip to one of the first and second container portions;
wherein the inner surface of the band strip is configured to engage at least one of the first and second outer surfaces such that the sealing surfaces of the first and second flanges are fixed with respect to one another when the band strip is attached to at least one of the first and second container portions;
wherein the outer profiles of the first and second flanges form together a V-shaped outer profile; and
wherein the inner profile of the band strip is configured to sufficiently conform to the V-shaped outer profile such that a clamping force biases the sealing surfaces of the first and second flanges toward one another.

12. The powertrain of claim 11, wherein the first container portion is an engine block.

13. The powertrain of claim 12, wherein the second container portion is a pan made of a non-metal material.

14. The powertrain of claim 13, wherein the engine block is made of one of a non-metal material and a composite material.

15. The powertrain of claim 11, wherein the first container portion is a transmission housing.

16. The powertrain of claim 15, wherein the second container portion is a pan made of a non-metal material.

17. The powertrain of claim 16, wherein the transmission housing is made of one of a non-metal material and a composite material.

18. A vehicle including a container having flanged portions, comprising:
a joint assembly configured to secure together the flanged portions of the container, including:
a first container portion having a first flange including a first sealing surface and a first outer surface;
a second container portion having a second flange including a second sealing surface and a second outer surface, wherein the second sealing surface is configured to cooperate with the first sealing surface to form together a sealed connection configured to retain a fluid in the container;
a band strip having an inner surface; and
a fastener configured to attach the band strip to one of the first and second container portions;
wherein the inner surface of the band strip is configured to engage at least one of the first and second outer surfaces such that the sealing surfaces of the first and second flanges are fixed with respect to one another when the band strip is attached to at least one of the first and second container portions.

19. The vehicle of claim 18, wherein the first outer surface of the first flange has a first outer profile, the second outer surface of the second flange has a second outer profile, and the inner surface of the band strip has an inner profile;
wherein the outer profiles of the first and second flanges form together a V-shaped outer profile; and
wherein the inner profile of the band strip is configured to sufficiently conform to the V-shaped outer profile such that a clamping force biases the sealing surfaces of the first and second flanges toward one another.

20. The vehicle of claim 18, wherein one of the first and second container portions is made of one of a non-metal material and a composite material.
